(19) United States
(12) Patent Application Publication
(10) Pub. No.: US 2023/0189797 A1
(43) Pub. Date: Jun. 22, 2023

(54) A STABILIZATION SYSTEM FOR AN AGROCHEMICAL COMPOSITION

(71) Applicant: UPL LTD, Mumbai (IN)

(72) Inventors: Mahesh Dharma Borane, Mumbai (IN); Popat Ganesh Chavan, Mumbai (IN); Pravin Namadeo More, Mumbai (IN)

(21) Appl. No.: 17/925,741

(22) PCT Filed: May 17, 2021
(86) PCT No.: PCT/IB2021/054198

§ 371 Date: Nov. 16, 2022

(30) Foreign Application Priority Data
May 18, 2020 (IN) 202021020816

(51) Int. Cl. A01N 25/22; A01P 7/04; A01N 25/04; A01N 47/34; A01N 43/56; A01N 43/36

(52) U.S. Cl. CPC A01N 25/22; A01P 7/04; A01N 25/04; A01N 47/34; A01N 43/56; A01N 43/36

(57) ABSTRACT

The present invention provides a stabilization system for an agrochemical composition comprising at least one steric stabilizer and at least one static stabilizer. The present invention further provides an aqueous insecticidal composition comprising at least one insecticide and said stabilization system. The present invention also discloses process of preparing aqueous insecticidal composition, a method of controlling pests and use of said composition as insecticide.

### FIELD OF THE INVENTION

The present invention relates to a stabilization system for an agrochemical composition. The present invention more specifically relates to a stabilization system for an agrochemical composition of poorly water-soluble compounds.

### BACKGROUND OF THE INVENTION

Poorly water-soluble compounds are difficult to develop as pesticide products and face great challenges in aqueous formulation development. During preparation of aqueous formulation, such as suspension concentrate composition of poorly water-soluble compounds, crucial step is to disperse the active compounds. The active particles should be dispersed so that each submicron or nanoscale particle can move independently. As long as the particles are separated, Brownian motion keeps them from sedimenting. A stable suspension is one in which there is a barrier keeping particles dispersed.

Agrochemicals are preferred to be formulated as aqueous suspension concentrate formulation, as these formulations contain no or only small amounts of organic volatiles. Suspension Concentrates [SCs] or Aqueous flowables (AFs) are concentrated suspensions of micronized active pesticide in water. These aqueous formulations are usually prepared by suspending the solid active ingredient in an aqueous system containing a suitable surfactant for stabilizing the solid particles of the active ingredient and then comminuting the active ingredient particles down to the desired particle size, which is normally below 10 μm. The suspension concentrate formulations of solid organic active ingredients tend to be unstable against settling of the active ingredient due to particle growth or agglomeration of the active compound particles. This becomes even difficult when active compound is insoluble or poorly soluble in water.

Prior to spraying on target areas, SCs are diluted with water in a spray tank to achieve the minimum effective pesticide concentration. SCs must be formulated for low viscosity and good fluidity so that transfer to the spray tank is easy and complete. When the active ingredients in SCs are insoluble, good suspension stability is essential. If the suspension settles and leaves sediment at the bottom of the container, the application of the pesticide may be too weak to be effective. Also, disposal of the residue in the container becomes a problem. This requires an efficient dispersing agent to ensure adequate dispersion of pesticide in water, especially poorly water-soluble pesticides.

A wide variety of poorly water insoluble active ingredients including insecticides, herbicides, fungicides, biocides, molluscicides, algaecides, plant growth regulators, anthelmintics, rodenticides, nematocides, acaricides, amoebicides, protozoacides, crop safeners and adjuvants are used in agricultural applications.

To formulate these diverse groups of active ingredients into a suitable formulation, an efficient system composed of suitable surfactants and dispersing agents; and in a balanced quantity is required. Commonly, the conventional surfactant materials are well known in the art and may be non-ionic, amphoteric, cationic or anionic or combinations of such surfactants.

Anionic surfactants consist of in most cases sulphonate, sulphate or carboxylate groups with either a sodium or a calcium as counterion. The non-ionic surfactants consist of polymerized glycol ether or glucose units. They are almost exclusively synthesized by the addition of ethylene oxide or propylene oxide to alkylphenols, fatty alcohols, fatty acids, fatty amines or fatty acid amides. Cationic surfactants contain quaternary ammonium ions as their hydrophilic parts. This class of surfactants has gained importance because of its bacteriostatic properties. Amphoteric surfactants containing both cationic and anionic group in their structure sometimes are referred to as zwitterionic molecules. The properties of amphoteric surfactants resemble those of non-ionics very closely.

Surfactants and dispersing agents help active ingredients to be formulated in great variety of ways by assisting in processing, stability, usability and effectiveness of the formulations. Surfactants also facilitate the dispersion of the poorly water-soluble pesticide particles in the aqueous medium and prevent aggregation of the particles themselves. In the absence of suitable surfactants, it becomes difficult or mostly, impossible to achieve stable formulation in a desired form. Therefore, it is highly desirable to design suitable system that facilitates formulation of poorly water-soluble active ingredients into suitable form.

### Objectives:

An object of the present invention is to provide a stabilization system for agrochemical composition.

Another object of the present invention is to provide a stabilization system for agrochemical composition of poorly water-soluble active ingredients.

Yet another object of the present invention is to provide a stabilization system for aqueous insecticidal composition of poorly water-soluble active ingredients.

Still another object of the present invention is to provide a process of preparing stabilization system for agrochemical composition.

Further object of the present invention is to provide a process of preparing aqueous insecticidal composition utilizing the stabilization system.

### SUMMARY OF THE INVENTION

In accordance with the above objectives, the present invention provides a stabilization system for an agrochemical composition comprising:
1) at least one steric stabilizer with hydrophilic-lipophilic balance value in the range 10-18; and
2) at least one static stabilizer;
   wherein the ratio of steric stabilizer to static stabilizer is about 5:1 to about 1:5 by weight.

In accordance with the above objectives, the present invention provides an aqueous insecticidal composition comprising:
1) at least one insecticide selected from diamide, neonicotinoid, pyrrole, benzoylphenyl urea and diacylhydrazine insecticides; and
2) a stabilization system comprising;
   a) at least one steric stabilizer with hydrophilic-lipophilic balance value in the range 10-18; and
   b) at least one static stabilizer;
      wherein the ratio of steric stabilizer to static stabilizer is about 5:1 to about 1:5 by weight. In accordance with the above objectives, the present invention provides an aqueous insecticidal composition comprising:
1) at least one insecticide selected from diamide, neonicotinoid, pyrrole, benzoylphenyl urea and diacylhydrazine insecticides;
2) at least one steric stabilizer with hydrophilic-lipophilic balance value in the range 10-18; and
3) at least one static stabilizer;
   wherein the ratio of steric stabilizer to static stabilizer is about 5:1 to about 1:5 by weight. In accordance with the above objectives, the present invention provides a process of preparing stabilization system for agrochemical composition comprising at least one steric stabilizer with hydrophilic-lipophilic balance value in the range 10-18; and at least one static stabilizer; wherein the ratio of steric stabilizer to static stabilizer is about 5:1 to about 1:5 by weight; and wherein said process comprises steps of: bringing together the steric stabilizer and static stabilizer to obtain mixture; and applying suitable form of energy to the mixture to obtain a stabilization system.

In accordance with the above objectives, a process of preparing stabilization system for agrochemical composition comprises at least one steric stabilizer with hydrophilic-lipophilic balance value in the range 10-18; and at least one static stabilizer; wherein the ratio of steric stabilizer to static stabilizer is about 5:1 to about 1:5 by weight; and wherein said process comprises steps of: adding static stabilizer to the steric stabilizer to obtain mixture; and applying suitable form of energy to the mixture to obtain said stabilization system.

In accordance with the above objectives, the present invention provides a process of preparing aqueous insecticidal composition comprises: at least one insecticide selected from diamide, neonicotinoid, pyrrole, benzoylphenyl urea and diacylhydrazine insecticides; at least one steric stabilizer with hydrophilic-lipophilic balance value in the range 10-18; and at least one static stabilizer; wherein the ratio of steric stabilizer to static stabilizer is about 5:1 to about 1:5 by weight; and wherein said process comprises step of: admixing insecticide and a stabilization system to obtain mixture; milling the resulting mixture to obtain uniform dispersion; and jellifying the uniform dispersion to obtain suspension concentrate composition.

In accordance with the above objectives, the present invention provides, a process of preparing aqueous insecticidal composition comprising at least one insecticide selected from of diamide, neonicotinoid, pyrrole, benzoylphenyl urea and diacylhydrazine insecticides; a stabilization system comprising at least one steric stabilizer with hydrophilic-lipophilic balance value in the range 10-18; and at least one static stabilizer; wherein the ratio of steric stabilizer to static stabilizer is about 5:1 to about 1:5 by weight; and wherein said process comprises step of: admixing insecticide and a stabilization system to obtain mixture; milling the resulting mixture to obtain uniform dispersion; and jellifying the uniform dispersion to obtain suspension concentrate composition.

In accordance with the above objectives, the present invention provides a method of controlling undesired insects, said method comprising applying to the pests or to their locus an insecticidally effective amount of an aqueous insecticidal composition comprising:
1) at least one insecticide selected from the group comprising of diamide, neonicotinoid, pyrrole, benzoylphenyl urea and diacylhydrazine insecticides;
2) at least one steric stabilizer with hydrophilic-lipophilic balance value in the range 10-18; and
3) at least one static stabilizer;
   wherein the ratio of steric stabilizer to static stabilizer is about 5:1 to about 1:5 by weight. In accordance with the above objectives, the present invention provides use of stabilization system in formulating agrochemical compositions according to the present invention.

In accordance with the above objectives, the aqueous insecticidal composition controls pests and insects.

In accordance with the above objectives, the present invention provides a kit of an aqueous insecticidal composition comprising:
1) at least one insecticide selected from diamide, neonicotinoid, pyrrole, benzoylphenyl urea and diacylhydrazine insecticides; and
2) a stabilization system wherein said stabilization system comprising;
   a) at least one steric stabilizer with hydrophilic-lipophilic balance value in the range 10-18; and
   b) at least one static stabilizer;
      wherein the ratio of steric stabilizer to static stabilizer is about 5:1 to about 1:5 by weight.

Additional features and advantages of the present invention will be apparent from the detailed description that follows, which illustrates by way of example, the most preferred features of the present invention which are not to be construed as limiting the scope of the invention described herein.

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified composition/systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other fungicides or insecticide or plant growth promoting agents or adjuvants or excipients not specifically recited therein.

Surprisingly, inventors of the present invention found that a stabilization system for agrochemical compositions may be obtained when steric stabilizers with hydrophilic-lipophilic balance value in the range 10-18 are mixed with static stabilizer in the 5:1 to about 1:5 by weight ratio of steric stabilizer to static stabilizer.

Inventors found that such stabilization system is highly suitable for formulating agrochemical compositions of poorly water-soluble active ingredients. The inventive step of carefully selecting the type of steric stabilizer and static stabilizer as well as the ratio in which they are combined made the stabilization system suitable to formulate most of the aqueous formulation of poorly water-soluble active ingredients, combination of poorly water-soluble to greatly water-soluble or to another water-insoluble active ingredients.

It was found that the steric stabilizers within the narrow range of hydrophilic-lipophilic balance value of 10-18 are highly effective in dispersing poorly water-soluble active ingredients. These steric stabilizers also offer certain degree of wetting that gave impetus in easy formulation of a dispersion. The static stabilizers found most suitable for resisting inter particle aggregation force and prevents active ingredient particles from coming together in aqueous dispersion.

### Definitions

In certain embodiments, “poorly water soluble” refers to pesticides having solubility in deionized water at 20° C. of not greater than about 100 milligrams per liter (mg/L). In some embodiments, the pesticides have solubility in deionized water at 20° C. of not greater than about 75 mg/L. In some embodiments, the pesticides have solubility in deionized water at 20° C. of not greater than about 50 mg/L. In some embodiments, the pesticides have solubility in deionized water at 20° C. of not greater than about 25 mg/L.

In certain embodiments, “steric stabilizer” refers to additives that inhibit coagulation of suspensions. These additives include certain water-loving polymers and surfactants with water-loving chains, especially non-ionic surfactants. These additives are believed to cover the system in such a way that long loops and tails extend out into solution. Systems that are sterically stabilized tend to remain well dispersed even at high salt concentrations or under conditions where the zeta potentials of the surfaces are reduced to near zero.

In certain embodiments, “static stabilizer” refers to anionic surfactants that generate surface charge and surface potential in the aqueous suspensions that prevent aggregation by keeping dispersed particles well separated from each other and from surfaces. The main driving force for aggregation of particles or droplets is the universal van der Waals attraction, which increases very sharply at small separations. To overcome the van der Waals attraction, static stabilizers create repulsive force (energy) between the particles, particularly at intermediate and small separations.

Such a repulsive energy can be produced by charge separation and the creation of electrical double layers. Combination of the van der Waals attraction and double layer repulsion at various separation distances between the particles produce an energy-distance curve, which will have an energy barrier at intermediate separation and this provides static stabilisation in the suspensions. Static stabilizer carries anionic charge density which is the ratio of the number of negative charges on a monomeric unit of which the polymer is comprised to the molecular weight of said monomeric unit, and is expressed as milliequivalents (meq) of anionic groups per gram of polymer (meq/g).

In certain embodiments “hydrophilic-lipophilic balance (HLB)” refers to the size and strength of the hydrophilic and lipophilic moieties of a surfactant molecule. It is a numerical system used to describe the relationship between the water-soluble and oil-soluble parts of a nonionic surfactant. HLB numbers range from 1 to 30.

Therefore, in an embodiment of the present invention, a stabilization system for an agrochemical composition comprising:
1) at least one steric stabilizer with hydrophilic-lipophilic balance value in the range 10-18; and
2) at least one static stabilizer;
   wherein the ratio of steric stabilizer to static stabilizer is about 5:1 to about 1:5 by weight. According to an embodiment of the present invention, a stabilization system for an agrochemical composition comprises of a steric stabilizer with hydrophilic-lipophilic balance value in the range 10-18.

According to an embodiment of the present invention, steric stabilizer with hydrophilic-lipophilic balance value in the range 10-18 is selected from one or more of ethoxylated and propoxylated alcohol, methyl oxirane polymer with oxirane, polyoxyethylene alkyl ether, methyl methacrylate graft copolymer, Polyoxyethylene (20) oleyl ether, Polyoxyethylene (100) stearyl ether, and Poly(ethylene glycol)-block-poly(propylene glycol)-block-poly(ethylene glycol).

According to preferred embodiment of the present invention, steric stabilizer with hydrophilic-lipophilic balance value in the range 10-18 is selected from the group comprising of ethoxylated and propoxylated alcohol, methyl oxirane polymer with oxirane, polyoxyethylene alkyl ether and methyl methacrylate graft copolymer.

In an embodiment of the present invention, the stabilization system for an agrochemical composition comprises from about 1% to about 70% w/w and preferably from about 5% to about 60% w/w steric stabilizer of the total weight of the stabilization system for an agrochemical composition.

In a preferred embodiment of the present invention, the stabilization system for an agrochemical composition comprises from about 10% to about 50% w/w steric stabilizer of the total weight of the stabilization system for an agrochemical composition.

According to an embodiment of the present invention, a stabilization system for an agrochemical composition comprises of a static stabilizer.

According to an embodiment of the present invention, static stabilizer is selected from one or more of alkylnaphthalene sulfonate (ANS) condensate, sodium lignosulphonate, naphthylsulfonate, mono- and di-(C₁-C₁₆)-alkylnaphthylsulfonates, such as, for example, dibutylnaphthylsulfonate; condensates of naphthalenesulfonic acid, and (C₁-C₁₆)-alkylnaphthalenesulfonic acid or phenolsulfonic acid with formaldehyde (═(C₁-C₁₆)-naphthalenesulfonate/formaldehyde condensates, (C₁-C₁₆)-alkylnaphthalenesulfonate/formaldehyde condensates and phenolsulfonate/formaldehyde condensates).

According to preferred embodiment of the present invention, static stabilizer is selected from one or more of alkylnaphthalene sulfonate (ANS) condensate, sodium lignosulphonate, naphthylsulfonate, mono- and di-(C₁-C₁₆)-alkylnaphthylsulfonates, such as dibutylnaphthylsulfonate.

According to an embodiment of the present invention, a stabilization system for an agrochemical composition comprises of a static stabilizer with anionic charge density in the range 0.1-2.5 meq/g.

According to an embodiment of the present invention, a stabilization system for an agrochemical composition comprises of a static stabilizer with anionic charge density in the range 0.5-2.0 meq/g.

In an embodiment of the present invention, the stabilization system for an agrochemical composition comprises from about 0.1% to about 50% w/w and preferably from about 0.5% to about 40% w/w static stabilizer of the total weight of the stabilization system for an agrochemical composition.

In a preferred embodiment of the present invention, the stabilization system for an agrochemical composition comprises from about 1% to about 30% w/w static stabilizer of the total weight of the stabilization system for an agrochemical composition.

According to an embodiment of the present invention, the ratio of steric stabilizer to static stabilizer in the stabilization system for an agrochemical composition is about 5:1 to about 1:5 by weight.

According to an embodiment of the present invention, the ratio of steric stabilizer to static stabilizer in the stabilization system for an agrochemical composition is about 4:1 to about 1:4 by weight.

According to preferred embodiment of the present invention, the ratio of steric stabilizer to static stabilizer in the stabilization system for an agrochemical composition is about 3:1 to about 1:3 by weight.

In accordance with the above objectives, the present invention provides an aqueous insecticidal composition comprising:
1) at least one insecticide selected from diamide, neonicotinoid, pyrrole, benzoylphenyl urea and diacylhydrazine insecticides; and
2) a stabilization system comprising;
   a) at least one steric stabilizer with hydrophilic-lipophilic balance value in the range 10-18; and
   b) at least one static stabilizer;
      wherein the ratio of steric stabilizer to static stabilizer is about 5:1 to about 1:5 by weight. According to an embodiment of the present invention, an aqueous insecticidal composition comprises:
1) at least one insecticide selected from diamide, neonicotinoid, pyrrole, benzoylphenyl urea and diacylhydrazine insecticides.
2) at least one steric stabilizer with hydrophilic-lipophilic balance value in the range 10-18; and
3) at least one static stabilizer;
   wherein the ratio of steric stabilizer to static stabilizer is about 5:1 to about 1:5 by weight.

According to an embodiment of the present invention, an aqueous insecticidal composition comprises at least one insecticide selected from diamide, neonicotinoid, pyrrole, benzoylphenyl urea and diacylhydrazine insecticides.

According to an embodiment of the present invention, the diamide insecticide of an aqueous insecticidal composition is selected from afoxolaner, broflanilide, chlorantraniliprole, cyantraniliprole, cyclaniliprole, cyhalodiamide, flubendiamide, fluralaner, lotilaner, tetrachlorantraniliprole, and tetraniliprole.

According to preferred embodiment of the present invention, the diamide insecticide of an aqueous insecticidal composition is selected from one or more of chlorantraniliprole, cyantraniliprole, cyclaniliprole, tetrachlorantraniliprole and tetraniliprole.

According to an embodiment of the present invention, the neonicotinoid insecticide of an aqueous insecticidal composition is selected from one or more of clothianidin, dinotefuran, imidacloprid, imidaclothiz, thiamethoxam, nitenpyram, nithiazine, acetamiprid, cycloxaprid and thiacloprid.

According to preferred embodiment of the present invention, the neonicotinoid insecticide of an aqueous insecticidal composition is selected from one or more of clothianidin, imidacloprid, acetamiprid, thiamethoxam and thiacloprid.

According to an embodiment of the present invention, the pyrrole insecticide of an aqueous insecticidal composition is selected from Chlorfenapyr and [4-bromo-2-(4-chlorophenyl)-1-(ethoxy-methyl)-5-(trifluoromethyl) pyrrole-3-carbonitrile] (AC 303,630).

According to an embodiment of the present invention, the benzoylphenyl urea insecticide of an aqueous insecticidal composition is selected from bistrifluron, chlorbenzuron, chlorfluazuron, dichlorbenzuron, diflubenzuron, flucycloxuron, flufenoxuron, hexaflumuron, lufenuron, novaluron, noviflumuron, penfluron, teflubenzuron, triflumuron.

According to preferred embodiment of the present invention, the benzoylphenyl urea insecticide of an aqueous insecticidal composition is selected from novaluron, chlorbenzuron, chlorfluazuron, dichlorbenzuron, lufenuron and triflumuron.

According to an embodiment of the present invention, the diacylhydrazine insecticide of an aqueous insecticidal composition is selected from chromafenozide, furan tebufenozide, halofenozide, methoxyfenozide, tebufenozide and yishijing.

According to preferred embodiment of the present invention, the diacylhydrazine insecticide of an aqueous insecticidal composition is selected from chromafenozide and Methoxyfenozide.

According to an embodiment of the present invention, an aqueous insecticidal composition comprises from about 0.1% to about 70% w/w and preferably from about 1% to about 60% w/w insecticide of the total weight of the aqueous insecticidal composition.

According to an embodiment of the present invention, an aqueous insecticidal composition comprises from about 10% to about 50% w/w insecticide of the total weight of the aqueous insecticidal composition.

In an embodiment of the present invention, the aqueous insecticidal composition may further comprise one or more antifreeze agent, wetting agents, fillers, surfactants, anticaking agents, pH-regulating agents, preservatives, biocides, antifoaming agents, colorants and other formulation aids.

Suitable antifreeze agents that can be added to the aqueous insecticidal composition are aqueous polyols, for example ethylene glycol, propylene glycol or glycerol. Suitable pH regulating agents can be citric acid or phosphoric acid or the like.

Wetting agents that can be added to the aqueous insecticidal composition of the present invention include, but are not limited to polyarylalkoxylated phosphate esters and their potassium salts such as Soprophor® FLK and Stepfac TSP PE-K. Other suitable wetting agents include Block copolymer of polyalkylene oxide, sodium dioctylsulfosuccinates such as Geropon® SDS and Aerosol® OT and ethoxylated alcohols such as Trideth-6, Rhodasurf® BC 610, Tersperse® 4894, Poly(oxy-1,2-ethanediyl), and .alpha.-[3-[1,3,3,3-tetramethyl-1-[(trimethylsilyl)oxy]-1disiloxanyl]propyl]-.omega.-hydroxy-(Silwet 408).

Optionally, about 0.1 wt % to about 5.0 wt % of antifoaming or defoamers are employed to stop any unwanted foam generated while manufacturing suspension concentrate composition of the present application. The preferred antifoaming agent is selected from silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. Defoamers that are suitable include AGNIQUE DFM 1115; SAG-10; SAG-1000AP; SAG-1529; SAG-1538; SAG-1571; SAG-1572; SAG-1575; SAG-2001; SAG-220; SAG-290; SAG-30; SAG-30E; SAG-330; SAG-47; SAG-5440; SAG-7133 and SAG-770.

Examples of thickening agents based on anionic heteropolysaccharides from the xanthan gum group are Rhodopol 23®, Rhodopol G®, Rhodopol 50 MD®, Rhodicare T®, Kelzan®, Kelzan S® and Satiaxane CX91®.

Examples of Preservatives are benzisothiazolinone (Proxel GXL) or phenols, 2-bromo-2-nitropropane-1,3-diol (Bioban BP 30), 5-chloro-2-methyl-4-isothiazolin-3-one & 2 methyl-4-isothiazolin-3 one (Kathon CG/ICP), Glutaraldehyde (Ucarcide 50), Chloromethylisothiazolinone (CMIT)/Methylisothiazolinone (MIT) (Isocil Ultra 1.5), 2.2-dibromo-3-nitrilopropioamide (Reputain 20), and Natamycin & Nisin, Bronopol/CMIT/MIT (Mergal 721K3).

Suitable colorants for example in red, blue and green are, preferably, pigments, which are sparingly soluble in water, and dyes, which are water-soluble. Examples of inorganic coloring agents are iron oxide, titanium oxide, and iron hexacyanoferrate and organic coloring agents are alizarin, azo and phthalocyanin coloring agents.

In an embodiment of the present invention, an aqueous insecticidal composition comprises from about 1% to about 70% w/w diamide or pyrrole or benzoylphenyl urea or diacylhydrazine insecticide and from about 1% to about 70% stabilization system of the total weight of the aqueous insecticidal composition.

In an embodiment of the present invention, an aqueous insecticidal composition comprises from about 0.1% to about 50% w/w diamide insecticide and from about 1% to about 50% stabilization system of the total weight of the aqueous insecticidal composition.

In an embodiment of the present invention, an aqueous insecticidal composition comprises from about 10% to about 50% w/w diamide insecticide and from about 10% to about 50% stabilization system of the total weight of the aqueous insecticidal composition.

In an embodiment of the present invention, an aqueous insecticidal composition comprises from about 10% to about 50% w/w diamide insecticide, at least one another insecticide and from about 10% to about 50% stabilization system of the total weight of the aqueous insecticidal composition.

In an embodiment of the present invention, an aqueous insecticidal composition comprises from about 1% to about 70% w/w diamide insecticide, from about 1% to about 70% pyrrole or benzoylphenyl urea or diacylhydrazine insecticide and; from about 1% to about 70% stabilization system of the total weight of the aqueous insecticidal composition.

In an embodiment of the present invention, an aqueous insecticidal composition comprises from about 0.1% to about 50% w/w chlorantraniliprole and from about 1% to about 50% stabilization system of the total weight of the aqueous insecticidal composition.

In an embodiment of the present invention, an aqueous insecticidal composition comprises from about 0.1% to about 50% w/w cyantraniliprole and from about 1% to about 50% stabilization system of the total weight of the aqueous insecticidal composition.

In an embodiment of the present invention, an aqueous insecticidal composition comprises from about 0.1% to about 50% w/w chlorantraniliprole and one or more another insecticide.

In an embodiment of the present invention, an aqueous insecticidal composition comprises from about 2% to about 50% w/w chlorantraniliprole, from about 05% to about 50% w/w chlorfenapyr and from about 10% to about 50% stabilization system of the total weight of the aqueous insecticidal composition.

In an embodiment of the present invention, an aqueous insecticidal composition comprises from about 5% to about 50% w/w chlorantraniliprole, from about 05% to about 50% w/w novaluron and from about 10% to about 50% stabilization system of the total weight of the aqueous insecticidal composition.

In an embodiment of the present invention, an aqueous insecticidal composition comprises from about 10% to about 50% w/w chlorantraniliprole, from about 10% to about 50% w/w methoxyfenozide and from about 10% to about 50% stabilization system of the total weight of the aqueous insecticidal composition.

In an embodiment of the present invention, an aqueous insecticidal composition comprises from about 5% to about 60% w/w chlorantraniliprole, from about 10% to about 90% w/w diflubenzuron and from about 10% to about 50% stabilization system of the total weight of the aqueous insecticidal composition.

In an embodiment of the present invention, an aqueous insecticidal composition comprises from about 1% to about 70% w/w diamide insecticide, from about 1% to about 70% flupyrimin and; from about 1% to about 70% stabilization system of the total weight of the aqueous insecticidal composition.

In an embodiment of the present invention, an aqueous insecticidal composition is formulated as suspension concentrate, soluble liquid, emulsion-in-water, formulation for seeds (FS).

In preferred embodiment the present aqueous insecticidal composition is a suspension concentrate.

According to an embodiment of the present invention, there is provided a process of preparing stabilisation system for agrochemical composition comprising at least one steric stabilizer with hydrophilic-lipophilic balance value in the range 10-18; and at least one static stabilizer; wherein the ratio of steric stabilizer to static stabilizer is about 5:1 to about 1:5 by weight; and wherein said process comprises steps of: bringing together the steric stabilizer and static stabilizer to obtain mixture; and applying suitable form of energy to the mixture to obtain a stabilization system.

According to an embodiment of the present invention, there is provided a process of preparing stabilisation system agrochemical composition comprising at least one steric stabilizer with hydrophilic-lipophilic balance value in the range 10-18; and at least one static stabilizer; wherein the ratio of steric stabilizer to static stabilizer is about 5:1 to about 1:5 by weight; and wherein said process comprises steps of bringing together the steric stabilizer and static stabilizer to obtain mixture; optionally adding water to the mixture and applying suitable form of energy to obtain the stabilization system.

According to an embodiment of the present invention, there is provided a process of preparing stabilization system for agrochemical composition comprising at least one steric stabilizer with hydrophilic-lipophilic balance value in the range 10-18; and at least one static stabilizer; wherein the ratio of steric stabilizer to static stabilizer is about 5:1 to about 1:5 by weight; and wherein said process comprises steps of: adding static stabilizer to the steric stabilizer to obtain mixture; and applying suitable form of energy to the mixture to obtain said stabilization system.

According to an embodiment of the present invention, there is provided a process of preparing stabilisation system for an agrochemical composition comprising at least one steric stabilizer with hydrophilic-lipophilic balance value in the range 10-18; and at least one static stabilizer; wherein the ratio of steric stabilizer to static stabilizer is about 5:1 to about 1:5 by weight; and wherein said process comprises steps of:
bringing together an ethoxylated and propoxylated alcohol based steric stabilizer and sodium salt of naphthalene sulfonate condensate as static stabilizer and water to obtain mixture; and applying suitable form of energy to the mixture to obtain the stabilization system.

According to an embodiment of the present invention, there is provided a process of preparing aqueous insecticidal composition comprising at least one insecticide selected from the group comprising of diamide, neonicotinoid, pyrrole, benzoylphenyl urea and diacylhydrazine insecticides; at least one steric stabilizer with hydrophilic-lipophilic balance value in the range 10-18; and at least one static stabilizer; wherein the ratio of steric stabilizer to static stabilizer is about 5:1 to about 1:5 by weight; and wherein said process comprises steps of:
admixing insecticide and a stabilization system to obtain mixture; milling the resulting mixture to obtain uniform dispersion; and jellifying the uniform dispersion to obtain suspension concentrate composition.

According to an embodiment of the present invention, a process of preparing said aqueous insecticidal composition comprises steps of:
admixing diamide insecticide and a stabilization system to obtain mixture; milling the resulting mixture to obtain uniform dispersion; and jellifying the uniform dispersion to obtain suspension concentrate and packaging the resulting aqueous insecticidal composition as suspension concentrate.

According to an embodiment of the present invention, a process of preparing said aqueous insecticidal composition comprises steps of:
admixing diamide insecticide, another insecticide selected from pyrrole, benzoylphenyl urea and diacylhydrazine insecticides and a stabilization system comprising ethoxylated and propoxylated alcohol based surfactant and sodium salt of naphthalene sulfonate condensate to obtain mixture; milling the resulting mixture to obtain uniform dispersion; and jellifying the uniform dispersion to obtain suspension concentrate and packaging the resulting aqueous insecticidal composition as suspension concentrate.

According to another embodiment of the present invention, in the process of preparation of an aqueous insecticidal composition, the sequence of mixing active ingredients, stabilization system comprising steric and static stabilizers, and optionally other ingredients is not fixed and may vary according to the preference of the formulator.

In an embodiment, the aqueous insecticidal composition of the invention has a particle size distribution D₁₀ of less than about 10 microns.

In an embodiment, the aqueous insecticidal composition of the invention has a particle size distribution D₁₀ of less than about 5 microns.

In an embodiment, the aqueous insecticidal composition of the invention has a particle size distribution D₅₀ of less than about 10.0 microns.

In an embodiment, the aqueous insecticidal composition of the invention has a particle size distribution D₅₀ of less than about 5 microns.

In an embodiment, the aqueous insecticidal composition of the invention has a particle size distribution D₅₀ of less than about 2 microns.

In an embodiment, the aqueous insecticidal composition of the invention has a particle size distribution D₉₀ of less than or equal to about 20 microns.

In an embodiment, the aqueous insecticidal composition of the invention has a particle size distribution D₉₀ of less than or equal to about 15 microns.

In an embodiment, the aqueous insecticidal composition of the invention has a particle size distribution D₉₀ of less than or equal to about 10 microns.

According to an embodiment of the present invention, the aqueous insecticidal composition prepared in above steps is subjected to particle size reduction by applying shear to the mixture of active ingredients, stabilization system and other auxiliary agents. Suitable devices for this purpose are the devices that offer milling operation such as high shear mixers like ROS HSM, Ultra-Turrax apparatus, and dissolvers, static mixers such as systems having mixing nozzles, bead mills, vibratory mills, agitator bead mills, colloid mills, cone mills, circulating mills (agitator ball mills with pin grinding system), disk mills, annular chamber mills, double cone mills, sprocket dispersers or homogenizers and other homogenizers.

In an embodiment of the present invention, an aqueous insecticidal composition comprises from about 1% to about 70% w/w diamide or pyrrole or benzoylphenyl urea or diacylhydrazine insecticide or mixtures thereof and from about 1 to about 70% stabilization system of the total weight of the aqueous insecticidal composition wherein said aqueous insecticidal composition is formulated as suspension concentrate.

In an embodiment the present invention provides suspension concentrate comprising from about 1% to about 70% w/w diamide or pyrrole or benzoylphenyl urea or diacylhydrazine insecticide or mixtures thereof and from about 1 to about 70% stabilization system of the total weight of the aqueous insecticidal composition.

In an embodiment of the present invention, an aqueous insecticidal composition comprises from about 1% to about 70% w/w diamide insecticide and from about 1 to about 70% stabilization system of the total weight of the aqueous insecticidal composition wherein said aqueous insecticidal composition is formulated as suspension concentrate.

In an embodiment of the present invention, an aqueous insecticidal composition comprises from about 1% to about 70% w/w diamide insecticide, from about 1% to about 70% stabilization system, from about 20% to about 80% water, from about 0.1% to about 40% wetting agent, from about 0.1% to about 10% antifreezing agent, from about 0.1% to about 5% defoamer, from about 0.1% to about 5% biocide, and from about 0.1% to about 5% rheology modifier of the total weight of the aqueous insecticidal composition wherein said aqueous insecticidal composition is formulated as suspension concentrate.

In an embodiment of the present invention, a aqueous insecticidal composition comprises from about 10% to about 50% w/w chlorantraniliprole, from about 1% to about 40% ethoxylated and propoxylated alcohol based steric stabilizer, from about 1% to about 40% sodium salt of naphthalene sulfonate condensate as static stabilizer, from about 10% to about 80% water, from about 0.1% to about 10% acrylic copolymer solution, from about 0.1% to about 5% silicone defoamer, from about 0.1% to about 5% biocide, and from about 0.1% to about 5% xanthan gum of the total weight of the aqueous insecticidal composition wherein said aqueous insecticidal composition is formulated as suspension concentrate.

According to an embodiment of the present invention, the aqueous insecticidal composition is designed to be diluted with water (or a water-based aqueous) to form the corresponding end-use agrochemical formulations, typically spray formulations.

According to an embodiment of the present invention, the aqueous insecticidal composition has a pH ranging from 5-9.

According to an embodiment of the present invention, the aqueous insecticidal compositions have a variation in pH of no more than 20% when at 54° C. between 24 hours and 28 days.

According to an embodiment of the present invention, the aqueous insecticidal composition allows the active compounds to be taken up by the pests and insects.

According to an embodiment of the present invention, the aqueous insecticidal composition is used as the source of active agrochemical ingredients and will typically be diluted to form end-use formulations, typically spray formulations. The dilution may be with water at from 1 to 10,000, particularly 10 to 1,000 times the total weight of the aqueous insecticidal composition to form the spray formulation. Said aqueous insecticidal composition may be diluted for use having an agrochemical active concentration of about 0.5 wt. % to about 1 wt. %. In said diluted composition, the agrochemical active concentration may be in the range from about 0.001 wt. % to about 1 wt. % of the total formulation as sprayed.

Spray formulations include all the components which are desired to apply to the plants or their environment. Spray formulations can be made up by simple dilution of aqueous insecticidal composition containing agrochemically active ingredients, or by mixing of the individual agrochemically active ingredients, or a combination of diluting an aqueous insecticidal composition and adding further individual agrochemically active ingredients or mixtures of agrochemically active ingredients. Typically, such end use mixing is carried out in the tank from which the formulation is sprayed, or alternatively in a holding tank for filling the spray tank. Such mixing and mixtures are typically termed tank mixing and tank mixtures.

In accordance with the above objectives, the present invention provides a method of controlling undesired insects, said method comprising applying to the pests or to their locus an insecticidally effective amount of an aqueous insecticidal composition comprising:
1) at least one insecticide selected from diamide, neonicotinoid, pyrrole, benzoylphenyl urea and diacylhydrazine insecticides;
2) at least one steric stabilizer with hydrophilic-lipophilic balance value in the range 10-18; and
3) at least one static stabilizer;
   wherein the ratio of steric stabilizer to static stabilizer is about 5:1 to about 1:5 by weight. In accordance with the above objectives, the present invention provides a method of controlling undesired insects, said method comprising applying to the pests or to their locus an insecticidally effective amount of an aqueous insecticidal composition comprising: (1) chlorantraniliprole; (2) polyoxyethylene alkyl ether as steric stabilizer with hydrophilic-lipophilic balance value in the range 10-18; and (3) sodium salt of naphthalene sulfonate condensate as static stabilizer.

In accordance with the above objectives, the present invention provides a method of controlling undesired insects, said method comprising applying to the pests or to their locus an insecticidally effective amount of an aqueous insecticidal composition comprising: (1) chlorantraniliprole; (2) chlorfenapyr; (3) ethoxylated and propoxylated alcohol based steric stabilizer with hydrophilic-lipophilic balance value in the range 10-18; and (4) sodium salt of naphthalene sulfonate condensate as static stabilizer.

In accordance with the above objectives, the present invention provides a method of controlling undesired insects, said method comprising applying to the pests or to their locus an insecticidally effective amount of an aqueous insecticidal composition comprising: (1) chlorantraniliprole; (2) methoxyfenozide; (3) ethoxylated and propoxylated alcohol based steric stabilizer with hydrophilic-lipophilic balance value in the range 10-18; and (4) sodium salt of naphthalene sulfonate condensate as static stabilizer.

In accordance with the above objectives, the present invention provides a method of controlling undesired insects, said method comprising applying to the pests or to their locus an insecticidally effective amount of an aqueous insecticidal composition comprising: (1) chlorantraniliprole; (2) novaluron; (3) methyl oxirane polymer with oxirane as steric stabilizer with hydrophilic-lipophilic balance value in the range 10-18; and (4) sodium lignosulfonate as static stabilizer.

According to an embodiment of the present invention, the stabilization system is used in formulating agrochemical compositions.

According to an embodiment of the present invention, the stabilization system is used in formulating aqueous insecticidal compositions.

According to an embodiment of the present invention, the aqueous insecticidal composition controls pests and insects.

In an embodiment of the present invention, the aqueous insecticidal composition controls pests and insects listed below;

Insects from the order of the Lepidoptera, for example Agrotis ipsilon, Chilo infuscatellus, Chilo partellus, Chilo suppressalis, Cnaphalocrocis medinalis, Cydia pomonella, Earias vittella, Earias insulana, Helicoverpa armigera, Leucinodes orbonalis, Maruca testulalis, Mythimna separata, Pectinophora gossypiella, Phyllocnistis citrella, Pieris bras-sicae, Plutella xylostella, Scirpophaga incertulas, Sesamia inferens, Spodoptera frugiperda, Spodoptera littoralis, Spodoptera litura, Tryporyza novella, Tuta absoluta and Zeiraphera canadensis. Beetles (Coleoptera), for example Diabrotica longicornis, Diabrotica semipunctata, Diabrotica punctata, Diabrotica speciosa, Diabrotica virgifera, Dicladispa armigera, Epila-chna varivestis, Holotrichia bicolor, Holotrichia consanguinea, Leptinotarsa decemlineata, flies (Diptera), e.g. Atherigona orientalis, Dacus cucurbi-tae, Liriomyza trifolii, Melanagromyza obtuse, thrips (Thysanoptera), e.g. Frankliniella occidentalis, Frankliniella tritici, Scirtothrips citri, Scirtothrips dorsalis, Thrips oryzae, Thrips palmi and Thrips tabaci, termites (Isoptera), e.g. Calotermes flavicollis, Coptotermes formosanus, Heterotermes aureus, Leucotermes flavipes, Microtermes obesi, Odontotermes obesus, Reticulitermes flavipes, Termes natalensis. true bugs (Hemiptera), e.g. Amrasca biguttula biguttula, Amrasca devastans, Amritodus atkinsoni, Aphis gossypii, Aphis crassivora, Bemisia argentifolii, Bemisia tabaci, Dysdercus cingulatus, Empoasca fabae, Idioscopus spp. My-zus persicae, Nilaparvata lugens, Nephotettix virescens, Nephotettix nigropictus, Planococcus spp., Pseudococcus spp., Pyrilla perpusilla, Sogatella furcifera, Trialeurodes vaporariorum, Toxoptera aurantiia, Psylla spp., Rhopalosiphum spp., Sitobion spp.

According to an embodiment of the present invention, the aqueous insecticidal composition can be applied to any and all developmental stages of pests, such as egg, larva, pupa, and adult. The pests may be controlled by contacting the target pest, its food supply, habitat, breeding ground or its locus with an effective amount of said composition of the present invention.

According to an embodiment of the present invention, the aqueous insecticidal compositions comprising various mixtures are highly effective in controlling insect pests, in GMO (Genetically Modified Organism) and Non GMO varieties of Cotton (Gossypium spp.), Paddy (Oryza sativa), Wheat (Triticum aestavum), Maize (Zea mays), Sugarcane (Saccharum officinarum), Sugarbeet (Beta vulgaris), Soybean (Glycin max), Peanut (Arachis hypogaea), Green gram (Vigna radiata), Black gram (Vigna mungo), Chickpea (Cicer aritinum), Redgram (Cajanus cajan), Brinjal (Solanum melongena), Cabbage (Brassica oleracea var. capitata), Cauliflower (Brassica oleracea var. botrytis), Okra (Abelmoschus esculentus), Onion (Allium cepa L.), Tomato (Solanum lycopersicun), Potato (Solanum tuberosum), Chilly (Capsicum annum), Garlic (Allium sativum), Cucumber (Cucumis sativus), Muskmelons (Cucumis melo), Watermelon (Citrullus lanatus), Bottle gourd (Lagenaria siceraria), Apple (Melus domestica), Banana (Musa spp.), Citrus groups (Citrus spp.), Grape (Vitis vinifera), Guava (Psidium guajava), Litchi (Litchi chinensis), Mango (Mangifera indica), Papaya (Carica papaya), Pineapple (Ananas comosus), Pomegranate (Punica granatum), Tea (Camellia sinensis), Coffea (Coffea arabica), Turmeric (Curcuma longa), Ginger (Zingiber officinale), Cumin (Cuminum cyminum).

In accordance with the above objectives, the present invention provides a kit of an aqueous insecticidal composition comprising:
1) at least one insecticide selected from diamide, neonicotinoid, pyrrole, benzoylphenyl urea and diacylhydrazine insecticides; and
2) a stabilization system comprising;
   a) at least one steric stabilizer with hydrophilic-lipophilic balance value in the range 10-18; and
   b) at least one static stabilizer;
      wherein the ratio of steric stabilizer to static stabilizer is about 5:1 to about 1:5 by weight. According to an embodiment of the present invention, the various components of the aqueous insecticidal composition can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare an aqueous insecticidal composition. For example, kits may include active ingredients and/or stabilization system. One or more of the components may already be combined together or pre-formulated. In those embodiments, where more than two components are provided in a kit, the components may already be combined together and packaged in a single container such as a vial, bottle, can, pouch, bag or canister.

In other embodiments, two or more components of a kit may be packaged separately, i. e., not pre-formulated. As such, kits may include one or more separate containers such as vials, cans, bottles, pouches, bags or canisters, each container containing a separate component for aqueous insecticidal composition.

In both forms, a component of the kit may be applied separately from or together with the further components or as a component of a combination composition according to the invention for preparing the aqueous insecticidal composition according to the invention.

In a preferred embodiment of the present invention, the aqueous insecticidal composition comprises (a) diamide or neonicotinoid or pyrrole or benzoylphenyl urea or diacylhydrazine insecticides or mixture thereof and; (b) stabilization system is in the form of a kit with single pack or multi pack.

All the features described herein may be combined with any of the above aspects, in any combination.

In order that the present invention may be more readily understood, reference will now be made, by way of example, to the following description. It will be understood that all tests and physical properties listed have been determined at atmospheric pressure and room temperature (i.e. 25° C.), unless otherwise stated herein, or unless otherwise stated in the referenced test methods and procedures.

### EXAMPLES

### Example-1: 5:1% Stabilization System

| Ingredients | Amount (% w/w) |
|---|---|
| Block copolymer of polyalkylene | 50 |
| oxide | |
| Sulphonated aromatic polymer, | 10 |
| sodium salt | |
| Water | q.s. |

50 g block copolymer of polyalkylene oxide and 10 g sulphonated aromatic polymer, sodium salt were mixed together and water was added under continuous stirring to obtain stabilization system.

### Example-2: 3:1% Stabilization System

| Ingredients | Amount (% w/w) |
|---|---|
| NPE-free nonionic polyalkylene | 45 |
| glycol ether | |
| Acrylic copolymer solution | 15 |
| Water | q.s. |

45 g NPE-free nonionic polyalkylene glycol ether (Atlas G-5000°), 15 g acrylic copolymer solution and water were added under continuous stirring to obtain stabilization system.

### Example-3: 5:1% Stabilization System

| Ingredients | Amount (% w/w) |
|---|---|
| NPE-free nonionic polyalkylene | 2.5 |
| glycol ether | |
| Sulphonated aromatic polymer, | 0.5 |
| sodium salt | |
| Water | q.s. |

2.5 g NPE-free nonionic polyalkylene glycol ether, 0.5 g Sulphonated aromatic polymer, sodium salt and water were added under continuous stirring to obtain stabilization system.

### Example-4: 18.5% Chlorantraniliprole SC

| Ingredients | Amount (%) |
|---|---|
| Chlorantraniliprole | 19.5 |
| Propylene Glycol | 5.0 |
| Stabilization system | 3.0 |
| Silicone defoamer | 0.2 |
| Biocide | 0.2 |
| Xanthan gum | 0.25 |
| Water | Q.S. |
| Total | 100.00 |

71.85 g water was charged into slurry preparation vessel. 5 g propylene glycol, 3 g stabilization system, 0.2 g silicone defoamer, 0.2 g biocide and 0.25 g xanthan gum were charged to the slurry preparation vessel under continuous stirring to obtain slurry. The slurry was then fed to bead mill to achieve desired particle size. After slurry reaches desired particle size, it was transferred into gelling vessel. 0.25 g xanthan gum, 0.2 g biocide and 71.85 g water were mixed together under stirring to get the gel. Pre-weighed amount of gel was added into the gelling vessel and continued stirring. The mixture was subjected to homogenization for at least 1 hr. The homogenized mixture was then set for uniform gelling to obtain final suspension concentrate composition. The stabilization system was obtained by 2.5 g polyoxyethylene alkyl ether (NPE-free) and 0.5 g sodium salt of naphthalene sulfonate condensate (NSC).

### Example-5: 18.5% Chlorantraniliprole SC

| Ingredients | Amount (%) |
|---|---|
| Chlorantraniliprole | 19.50 |
| Propylene Glycol | 5.00 |
| Stabilization system | 2.8 |
| Antifoam | 0.2 |
| Biocide | 0.2 |
| Xanthan gum | 0.25 |
| Water | Q.S. |
| Total | 100.00 |

19.5 g chlorantraniliprole, 5.0 g propylene glycol, 2.8 g stabilization system, 0.2 g antifoam, 0.2 g biocide, 0.25 g xanthan gum and 72.35 g water were mixed in above quantity and processed as per the process given in Example-4 to obtain suspension concentrate composition. The stabilization system was obtained by mixing 2.5 g polyoxyethylene alkyl ether (NPE-free) and 0.3 g sodium salt of naphthalene sulfonate condensate (NSC).

### Example-6: 24 g/L Chlorantraniliprole+490 g/L Chlorfenapyr SC

| Ingredients | Amount (%) |
|---|---|
| Chlorantraniliprole | 2.4 |
| Chlorfenapyr | 49 |
| Stabilization system | 6.7 |
| Propylene glycol | 5.0 |
| Silicone antifoam | 0.7 |
| Biocide | 0.2 |
| Xanthan gum | 0.18 |
| Water | Q.S. |
| Total | 100.00 |

2.4 g chlorantraniliprole, 49 g Chlorfenapyr, 6.7 g stabilization system, 5.0 g propylene glycol, 0.7 g silicone antifoam, 0.2 biocide, 0.18 g xanthan gum and water in quantity required to make up volume were mixed in above quantity and processed as per the process given in Example-4 to obtain suspension concentrate composition. The stabilization system was obtained by mixing 3.5 g Block copolymer of polyalkylene oxide, 1.7 g polymer surfactant and 1.5 g sulphonated aromatic polymer, sodium salt.

### Example 7: 105 g/L Chlorantraniliprole+420 g/L Methoxyfenozide SC

| Ingredients | Amount (%) |
|---|---|
| Chlorantraniliprole | 10.5 |
| Methoxyfenozide | 42 |
| Stabilization system | 7.2 |
| Propylene glycol | 5.0 |
| Silicone antifoam | 0.7 |
| Biocide | 0.2 |
| Xanthan gum | 0.18 |
| Water | Q.S. |
| Total | 100.00 |

9.41 g chlorantraniliprole, 37.63 g Methoxyfenozide, 7.2 g stabilization system, 5.0 g propylene glycol, 0.7 g silicone antifoam, 0.2 biocide, 0.18 g xanthan gum and water in quantity required to make up volume were mixed in above quantity and processed as per the process given in Example-4 to obtain suspension concentrate composition. The stabilization system was obtained by mixing 3.5 g block copolymer of polyalkylene oxide, 1.7 g polymer surfactant and 2 g sulphonated aromatic polymer, sodium salt.

### Example 8: 92 g/L Novaluron+56 g/L Chlorantraniliprole SC

| Ingredients | Quantity (%) |
|---|---|
| Chlorantraniliprole | 5.73 |
| Novaluron | 9.18 |
| Stabilization system | 2.5 |
| Silicone antifoam | 0.20 |
| Propylene Glycol | 7.00 |
| Xanthan gum | 10.00 |
| Clay | 0.90 |
| Biocide | 0.10 |
| Water | Q.S. |
| Total | 100.00 |

5.73 g chlorantraniliprole, 9.18 g novaluron, 3.5 g stabilization system, 0.2 silicone antifoam, 7.0 g propylene glycol, 10.0 g xanthan gum, 0.9 g clay, 0.1 g biocide and 62.88 g water were mixed in above quantity and processed as per the process given in Example-4 to obtain suspension concentrate composition. The stabilization system was obtained by mixing 1 g sodium lignosulfonate and 1.5 g block copolymer solution.

### Example 9: Chlorantraniliprole 50+Diflubenzuron 400 g/L SC

| Ingredients | Amount (% w/w) |
|---|---|
| Chlorantraniliprole | 5 |
| Diflubenzuron | 40 |
| Propylene glycol | 5.00 |
| Stabilization system | 5.00 |
| Antifoam | 0.50 |
| Biocide | 0.15 |
| Xanthan gum | 0.20 |
| Water | Q.S. |
| Total | 100.00 |

Chlorantraniliprole, diflubenzuron, propylene glycol, antifoam, biocide, xanthan gum and water were mixed in above quantity and processed as per the process given in Example-4 to obtain suspension concentrate composition. Stabilization system comprised of 3 g Atlox 4894, 1.5 g acrylic copolymer solution and 0.5 g sodium alkylnaphthalenesulfonate formaldehyde polymer.

### Example 10: Chlorantraniliprole (CTPR) 400 g/L SC

| Ingredients | Quantity (% w/w) |
|---|---|
| Chlorantraniliprole | 36.31 |
| Propylene glycol | 5.00 |
| Stabilization system | 6.00 |
| Antifoam | 0.50 |
| Biocide | 0.20 |
| Xanthan gum | 0.20 |
| Water | Q.S. |
| Total | 100.00 |

Chlorantraniliprole, propylene glycol, stabilization system, antifoam, biocide, xanthan gum and water were mixed in above quantities and processed as per the process given in Example-4 to obtain suspension concentrate composition. Stabilization system comprised of 3 g Atlox 4894, 2.5 g Atlox 4913 and 0.5 g sodium alkylnaphthalenesulfonate formaldehyde polymer.

### Example 11: Chlorantraniliprole+Flupyrimin SC Composition

| Ingredients | Quantity (% w/w) |
|---|---|
| Chlorantraniliprole | 5.6 |
| Flupyrimin | 18.5 |
| Propylene glycol | 5.0 |
| Acrylic polymer | 1.0 |
| Acrylic copolymer solution | 2.50 |
| Ligno sulphonate | 0.50 |
| Silicone antifoam | 0.50 |
| Xanthan gum | 0.20 |
| Water | Q.S. |
| Total | 100.00 |

Required amount of water was charged into slurry preparation vessel. All the quality approved remaining RM ingredients Acrylic polymer (Envipol 871), Acrylic copolymer solution (Atlox 4913), Ligno sulphonate (Polyphon H) were added. Technical was added into the solution while stirring to form slurry. Milling was done and slurry was passed into gelling vessel. Required amount of Xanthan gum and preservative were charged in water under stirring to get gel. The material from gelling vessel was transferred to FG storage tank and to achieve the required level of structuring.

### Example 12

### Stability Data for the Compositions of the Present Invention

| | Example No 4 | | Example No 5 | |
|---|---|---|---|---|
| Parameters | Ambient | 14 Days AHS | Ambient | 14 Days AHS |
| Appearance | Off white color | Off white color | Off white colour | Off white color |
| | suspension | suspension | suspension | suspension |
| | concentrate free | concentrate free | concentrate free | concentrate free |
| | from extraneous | from extraneous | from extraneous | from extraneous |
| | matter. | matter. | matter | matter. |
| | No top separation | No top separation | | No top separation |
| | and sediment. | and sediment. | | and sediment. |
| Active content as | 18.60 | 18.58 | 19.05 | 19.04 |
| Chlorantraniliprole | | | | |
| pH (1.0% aqueous | 6.44 | 6.50 | 5.8 | 6.5 |
| suspension) | | | | |
| Wet sieve test Pass | 100 | 100 | 100 | 100 |
| through 45μ | | | | |
| (Min % w/w) | | | | |
| Suspensibility as Al | 96.2 | 95.6 | 96.31 | 96.19 |
| basis (% w/w) | | | | |
| Spontanity of | 104 | 102 | 108 | 107.7 |
| Dispersion as | | | | |
| Gravimetric (% w/w) | | | | |
| Persistent foam after | Nil | Nil | Nil | Nil |
| 1 min in ml. (In | | | | |
| standard hard | | | | |
| water D) | | | | |
| Density at 20° C. (g/ml) | 1.088 | NA | 1.084 | NA |
| Viscosity (in cP) (62 | 275 | 266 | 258 | 257 |
| spindle at 60 RPM) | | | | |
| Particle side | 0.90 | 0.59 | 0.70 | 0.70 |
| Distribution D10 | | | | |
| D50 | 1.97 | 1.41 | 1.98 | 1.86 |
| D90 | 6.43 | 5.43 | 6.52 | 5.63 |

| | Example 6 | | Example 7 | |
|---|---|---|---|---|
| Parameter | Ambient | 14 days AHS | Ambient | 14 days AHS |
| Appearance | Off white color | Off white color | Off white color | Off white color |
| | suspension | suspension | suspension | suspension |
| | concentrate free | concentrate free | concentrate free | concentrate free |
| | from extraneous | from extraneous | from extraneous | from extraneous |
| | matter. | matter. | matter. | matter. |
| Active ingredients | — | — | — | — |
| Methoxyfenozide | — | — | 432.15 | 423.54 |
| Chlorantraniliprole | 24.46 | 24.22 | 104.29 | 100.71 |
| Chlorfenapyr | 487.39 | 485.8 | | |
| pH (as such) | 6.62 | 6.51 | 6.58 | 6.56 |
| pH (1% Aqueous | NA | NA | NA | NA |
| solution) | | | | |
| Suspensibility | — | — | — | — |
| (Active) | | | | |
| Methoxyfenozide | — | — | 96.9 | 95.8 |
| Chlorantraniliprole | 96.6 | 95.6 | 97.2 | 97 |
| Chlorfenapyr | 90.3 | 83 | | |
| Wet Seive Test | 100 | 100 | 100 | 100 |
| (material passing | | | | |
| through 200 BSS | | | | |
| sieve) | | | | |
| Persitant of foam | 0 | 0 | 0 | 0 |
| in (20 PPM water) | | | | |
| after 5 min | | | | |
| Density | 1.22 | NA | 1.119 | NA |
| Viscosity 62 | 1872 | 1650 | 3120 | 2748 |
| spindle 5 RPM | | | | |
| Particle size | | | | |
| D 10 | 0.93 | 1.61 | 0.78 | 0.89 |
| D 50 | 3.04 | 4.43 | 2.36 | 2.76 |
| D 90 | 8.34 | 11.3 | 7.12 | 8.03 |

Example-8

| Parameters | Ambient | 14 days AHS |
|---|---|---|
| Appearance | Off white color | Off white color |
| | suspension | suspension |
| | concentrate free | concentrate free |
| | from extraneous | from extraneous |
| | matter. | matter. |
| % degradation Novaluron w/w | 9.05 | 9.06 |
| % degradation Clothianidine w/w | | |
| % degradation | 5.46 | 5.45 |
| Chlorantraniliprole w/w | | |
| suspensibility Novaluron % w/w | 95.6 | 93.9 |
| suspensibility Chlorantraniliprole | 97.5 | 96.8 |
| % w/w | | |
| 1% pH aqueous solution | 7.51 | 7.36 |
| Persistent foam in ml | 50 | 52 |
| Wet sieve retention on 75 micron | Nil | Nil |
| test sieve | | |
| Viscosity in cp at 20° C. | 386 | 403 |
| Particle size | | |
| D-10 | 0.697 | 0.761 |
| D-50 | 2.23 | 2.65 |
| D-90 | 6.98 | 7.94 |
| D-95 | 9.31 | 10.4 |
| D-mean | 3.34 | 3.76 |

| | |
|---|---|
| Example-9 | Example-10 |

| Parameter | Ambient | 14 days AHS | Ambient | 14 days AHS |
|---|---|---|---|---|
| Appearance | Off white color | Off white color | Off white color | Off white color |
| | suspension | suspension | suspension | suspension |
| | concentrate free | concentrate free | concentrate free | concentrate free |
| | from extraneous | from extraneous | from extraneous | from extraneous |
| | matter. | matter. | matter. | matter. |
| Active ingredients | | | | |
| Diflubenzuron | 400.5 | 400.6 | | |
| Chlorantraniliprole | 50.5 | 50.1 | 410 | 409.4 |
| pH (as such) | NA | NA | NA | NA |
| pH (1% Aqueous | 6.07 | 5.95 | 6.60 | 6.32 |
| solution) | | | | |
| Suspensibility | | | | |
| (Active) | | | | |
| Diflubenzuron | 99.2 | 99.0 | | |
| Chlorantraniliprole | 95.5 | 94.5 | 95.4 | 92.30 |
| Wet Seive Test | 100 | 100 | 100 | 100 |
| (material passing | | | | |
| through 200 BSS | | | | |
| sieve) | | | | |
| Persitant of foam in | 0 | 0 | 0 | 0 |
| (20 PPM water) after | | | | |
| 5 min | | | | |
| Density | 1.170 | NA | 1.176 | NA |
| Viscosity 62 spindle | 304 | 297 | 348 | 326 |
| 60 RPM | | | | |
| Particle size | | | | |
| D 10 | 0.91 | 1.07 | 0.67 | 0.72 |
| D 50 | 2.96 | 3.38 | 1.82 | 1.90 |
| D 90 | 8.80 | 10.0 | 6.82 | 7.0 |

### CONCLUSION

The stabilization system developed according to the present invention successfully utilized in formulating aqueous insecticidal compositions of various active ingredients. It has been found that the stabilization system comprising the steric stabilizers within the narrow range of hydrophilic-lipophilic balance value of 10-18 are highly effective in dispersing poorly water-soluble active ingredients. These steric stabilizers also offer certain degree of wetting that gave impetus in easy formulation of a dispersion. The selected static stabilizers were found to be most suitable for resisting inter particle aggregation force and prevents active ingredient particles from coming together in aqueous dispersion. The careful selection of the ratio of steric stabilizer and static stabilizer in formulating stabilization system and utilizing said stabilization system in formulating aqueous insecticidal compositions achieved better stability. The aqueous insecticidal composition of the present invention provides excellent stability over time and at various temperatures. Also, the aqueous insecticidal composition obtained by the process have superior suspensibility, better dispersibility, very low or no sedimentation and little particle degradation.

1. A stabilization system for an agrochemical composition comprising:
a) at least one steric stabilizer with a hydrophilic-lipophilic balance value in the range of 10-18; and
b) at least one static stabilizer;
wherein the ratio of steric stabilizer to static stabilizer is about 5:1 to about 1:5 by weight.

2. The stabilization system for an agrochemical composition as claimed in claim 1, wherein said steric stabilizer is selected from ethoxylated alcohol, propoxylated alcohol, methyl oxirane polymer with oxirane, polyoxyethylene alkyl ether, methyl methacrylate graft copolymer, polyoxyethylene (20) oleyl ether, and polyoxyethylene (100) stearyl ether and poly(ethylene glycol)-block-poly(propylene glycol)-block-poly(ethylene glycol).

3. The stabilization system for an agrochemical composition as claimed in claim 1, wherein said static stabilizer is selected from alkylnaphthalene sulfonate (ANS) condensate, sodium lignosulphonate, naphthylsulfonate, mono- and di-(C1-C16)-alkylnaphthylsulfonates, condensates of naphthalenesulfonic acid, (C1-C16)-naphthalenesulfonate/formaldehyde condensates, (C1-C16)-alkylnaphthalenesulfonate/formaldehyde condensates, and phenolsulfonate/formaldehyde condensates.

4. The stabilization system for an agrochemical composition as claimed in claim 1, wherein the ratio of steric stabilizer to static stabilizer is 5:1 by weight.

5. The stabilization system for an agrochemical composition as claimed in claim 1, wherein the ratio of steric stabilizer to static stabilizer is 3:1 by weight.

6. The stabilization system for an agrochemical composition as claimed in claim 1, wherein said stabilization system comprises block copolymer of polyalkylene oxide as the steric stabilizer and sulphonated aromatic polymer, sodium salt as the static stabilizer in a 5:1 ratio by weight.

7. The stabilization system for an agrochemical composition as claimed in claim 1, wherein said stabilization system comprises polyoxyethylene alkyl ether (NPE-free) as the steric stabilizer and sodium alkylnaphthalene sulphonate as the static stabilizer in a 3:1 ratio by weight.

8. An aqueous insecticidal composition comprising:
a) at least one insecticide selected from the group consisting of diamide, neonicotinoid, pyrrole, benzoylphenyl urea and diacylhydrazine insecticides; and
b) the stabilization system of claim 1.

9. The aqueous insecticidal composition as claimed in claim 8, wherein the diamide insecticide is chlorantraniliprole.

10. The aqueous insecticidal composition as claimed in claim 8, wherein the neonicotinoid insecticide is selected from one or more of acetamiprid, imidacloprid, thiacloprid, thiamethoxam, dinotefuran, and clothianidine.

11. The aqueous insecticidal composition as claimed in claim 8, wherein the pyrrole insecticide is chlorfenapyr.

12. The aqueous insecticidal composition as claimed in claim 8, wherein the benzoylphenylurea insecticide is selected from one or more of chlorfluazuron, diflubenzuron, lufenuron, and novaluron.

13. The aqueous insecticidal composition as claimed in claim 8, wherein the diacylhydrazine insecticide is methoxyfenozide.

14. The aqueous insecticidal composition as claimed in claim 8, wherein said composition comprises from about 0.1% w/w to about 50% diamide insecticide, and from about 1% w/w to about 50% w/w stabilization system of the total weight of the aqueous insecticidal composition.

15. (canceled)

16. The aqueous insecticidal composition as claimed in claim 8, wherein said composition comprises chlorantraniliprole and novaluron.

17. The aqueous insecticidal composition as claimed in claim 8, wherein said composition comprises chlorantraniliprole and chlorfenapyr.

18. The aqueous insecticidal composition as claimed in claim 8, wherein said composition comprises chlorantraniliprole and methoxyfenozide.

19. The aqueous insecticidal composition as claimed in claim 8, wherein said composition comprises chlorantraniliprole and clothianidin.

20. The aqueous insecticidal composition as claimed in claim 8, wherein said composition comprises chlorantraniliprole and diflubenzuron.

21. The aqueous insecticidal composition as claimed in claim 8, wherein said composition comprises chlorantraniliprole and flupyrimin.

22. The aqueous insecticidal composition as claimed in claim 8, wherein the particle size distribution D₅₀ ranges from 2 micron to 10 micron.

23. The aqueous insecticidal composition as claimed in claim 8, wherein the particle size distribution D₉₀ ranges from 10 micron to 20 micron.

24. A process of preparing the stabilization system for an agrochemical composition according to claim 1, wherein said process comprises bringing together the steric stabilizer and the static stabilizer to obtain a mixture; and applying a form of energy to the mixture to obtain the stabilization system.

25. The process of preparing stabilization system for an agrochemical composition as claimed in claim 24, wherein said process comprises adding the static stabilizer to the steric stabilizer to obtain the mixture.

26. The process of preparing stabilization system as claimed in claim 24, wherein the form of energy is applied by way of continuous stirring to obtain a uniform stabilization system.

27. A process of preparing an aqueous insecticidal composition comprising at least one insecticide selected from diamide, neonicotinoid, pyrrole, benzoylphenyl urea and diacylhydrazine insecticides the stabilization system of claim 1; and wherein said process comprises admixing the insecticide and the stabilization system to obtain a mixture; milling the resulting mixture to obtain a uniform dispersion; and jellifying the uniform dispersion to obtain a suspension concentrate composition.

28. The process of preparing an aqueous insecticidal composition as claimed in claim 27 wherein the mixture is milled in the presence of water to obtain the uniform dispersion.

29. A method of controlling undesired insects, said method comprising applying to the pests or to their locus an insecticidally effective amount of an aqueous insecticidal composition of claim 8.

30. The method as claimed in claim 29, wherein the insecticide is chlorantraniliprole.
